(19) United States
(12) Patent Application Publication
(10) Pub. No.: US 2023/0074217 A1
(43) Pub. Date: Mar. 9, 2023

(54) Heating Apparatus

(71) Applicant: JT International SA, Geneva (CH)

(72) Inventors: Kyle Adair, Lisburn (GB); Andrew Robert John Rogan, Forres (GB); Alec Wright, Guildford (GB)

(73) Assignee: JT International SA, Geneva (CH)

(21) Appl. No.: 17/785,716

(22) PCT Filed: Dec. 18, 2020
(86) PCT No.: PCT/EP2020/087302

§ 371 Date: Jun. 15, 2022

(30) Foreign Application Priority Data
Dec. 19, 2019 (EP) 19218306.9

(51) Int. Cl. A24F 40/46; A24F 40/10; A24F 40/44; H05B 3/34

(52) U.S. Cl. CPC A24F 40/46; A24F 40/10; A24F 40/44; H05B 3/34; H05B 2203/021

(57) ABSTRACT

A heating apparatus for an aerosol generating device includes a heating element supported within a housing and extending along the length of the housing, an air flow path arranged to transport air over the heating element, and a liquid supply configured to supply liquid to the heating element, wherein the heating element includes a woven sheet of electrically conductive fibres, and wherein the fibres are arranged with a regular orientation to form a woven mesh that transports liquid by capillary action, in use. The woven sheet includes a first array of electrically conductive fibres extending in a first direction.

### CROSS-REFERENCE TO RELATED APPLICATIONS

The present application is a national phase entry under 35 U.S.C. § 371 of International Application No. PCT/EP2020/087302, filed Dec. 18, 2020, published in English, which claims priority to European Application No. 19218306.9 filed Dec. 19, 2019, the disclosures of which are incorporated herein by reference.

### FIELD OF THE INVENTION

The present invention relates to a heating apparatus for an aerosol generating device, such as an electronic cigarette.

### BACKGROUND OF THE INVENTION

Aerosol generating devices, such as electronic cigarettes, typically include a heating apparatus comprising a heating element for heating a vaporisable liquid, thereby producing a vapour for inhalation by a user. Generally, such devices comprise a liquid store and a liquid transport element or “wick” formed of a capillary material arranged to transport liquid from the liquid store to the heating element. In one known type of aerosol generating device, the heating element itself comprises a capillary material, for example a non-uniform mesh of fibres, such that it provides both the wicking function to transport liquid from the liquid store and the heating function.

However, such heating element arrangements are known to provide variable levels of heating performance, leading to unpredictable aerosol generating properties of the aerosol generating device. In particular, porous capillary heating elements generally have a non-uniform structure which means the heating properties vary over the heating element, making it difficult to provide constant, reproducible heater performance. Moreover, in the case of heating elements comprising a non-uniform mesh of fibres, individual fibres within the network often become loose and detach themselves from the heating element. This provides a significant safety risk to the user.

### BRIEF SUMMARY OF THE INVENTION

An object of the present invention is to address some of these issues.

According to an aspect of the invention there is provided a heating apparatus for an aerosol generating device, comprising a heating element supported within a housing and extending along the length of the housing, an air flow path arranged to transport air over the heating element, and a liquid supply configured to supply liquid to the heating element, wherein the heating element comprises a woven sheet of electrically conductive fibres, wherein the fibres are arranged with a regular orientation to form a woven mesh that transports liquid by capillary action, in use, and wherein the woven sheet comprises: a first array of electrically conductive fibres extending in a first direction.

In this way, the woven sheet provides a secure array of fibres, such that the risk of fibres becoming loose is significantly reduced and the safety of the device is improved. Furthermore, the regular orientation of fibres (i.e. the fibres are arranged in or constitute a constant or definite pattern) reduces the local variation in material properties such as conductivity and capillary properties. This results in a more robust and consistent heating operation, leading to an enhanced overall performance of the aerosol generating device. In contrast, within conventional aerosol generating devices, heating elements which utilise a mesh of fibres do not prioritise uniformity, e.g. they do not comprise fibres extending in a defined direction. Other types of conventional heating element may comprise heating grids with substantial gaps between heating wires. These factors result in aerosolisable liquid being unable to uniformly spread over the surface of the heating element, leading to a less reliable and less consistent heating operation.

The liquid supply may be a liquid store, i.e. a container arranged to hold an aerosol generating liquid, which is arranged such that the heating element is in contact with the liquid in use. In this way, liquid form the liquid store is drawn directly through the heating element as liquid is vaporised.

Preferably, the fibres are displaced at regular intervals. In this way, the wicking properties of the mesh remain consistent across the heating element.

Preferably, the woven sheet comprises a second array of electrically conductive fibres extending in a second direction, wherein the first array of fibres and the second array of fibres intersect to form the woven mesh. The mesh may be woven such that each fibre in the first array alternately winds over opposite sides of subsequent fibres of the second array, and such that each fibre in the second array alternately winds over opposite sides of subsequent fibres of the first array. In this way, two distinct arrays of fibres are interlaced in a plain weave arrangement, thereby providing a strong resistive force to fibre pull-out and increasing the mechanical strength of the mesh. In alternative arrangements, the fibres may be woven in a twill, basketweave, satin or leno arrangement, or any other woven pattern.

Preferably, the first and second directions are substantially orthogonal i.e. within a Cartesian coordinate system, the fibres of the first and second arrays extend parallel to the X and Y axes respectively.

Preferably, the housing comprises a tubular housing. For example, the housing may be substantially cylindrical.

Preferably, the housing comprises a first housing portion and a second housing portion that cooperatively engage along the length of the housing to define an interface, and wherein the heating element is supported in the interface between the first and second housing portions.

The fibre thickness in the first array of fibres may be different to the fibre thickness in the second array of fibres. In this way, the fibre resistance may be varied in different directions, enabling the establishment of temperature gradients across the heating element.

The heating apparatus may comprise at least one additional fibre woven into the mesh, wherein the at least one additional fibre comprises a different material to the fibres of the first and second array. In this way, properties of the heating element may be varied across the mesh. In one example, by weaving a material into the mesh which has a higher conductivity than the first, second and third arrays of fibres, a preferential current path may be provided across the heating element. In particular, a higher conductivity region may be provided by weaving a higher conductivity fibre across a region of the heating element.

The heating apparatus may comprise a third array of conductive fibres extending in a third direction, wherein the third array of fibres is arranged to intersect with the first array of fibres and the second array of fibres. Preferably, the third direction is substantially orthogonal to the first direction and the second direction, i.e. within a Cartesian coordinate system, the fibres of the first, second and third arrays extend parallel to the X, Y and Z axes respectively. In this way, a three dimensional heating element is provided, further improving the interlocking properties of the mesh so that the risk of fibre pull-out is further reduced.

At least two of the first, second and third arrays of fibres may comprise different materials. In this way, the wire resistance can be varied in different directions, enabling the establishment of temperature gradients across the heating element, or preferential paths for the current to flow.

At least one region of the mesh may be stretched or compressed relative to the surrounding mesh. In this way, the concentration of current may be varied across the heating element. A locally stretched region will produce an area of high current density, and a locally compressed region will produce an area of low current density. Areas of high current density will become hotter than areas of low current density, such that a temperature gradient is established across the mesh.

Preferably, the sheet of heating element comprises one or more slots extending inwardly from at least one edge of the sheet. In one example, the sheet of heating element may be formed such that it follows a serpentine path. In this way, a meandering current path may be provided along the heating element, resulting in different concentrations of current along the path, and the establishment of temperature gradients across the heating element.

A thickness of the mesh in a central region may be greater than the thickness of the mesh in a peripheral region. In this way, wicking properties of the mesh may be varied across the heating element. An increased thickness of mesh in the centre of the heating element will encourage capillary action, such that more liquid is stored centrally within the heating element.

Preferably, the liquid supply at least partially surrounds the housing and is configured to directly interface with the heating element along the length of the housing. In this way, a compact device is provided which delivers a reliable supply of liquid to the heating element along the length of the housing. This ensures a consistent vapour is generated and delivered to the user. Moreover, direct interfacing of the heating element with the liquid supply removes the requirement for an additional wick component, thereby reducing the cost and complexity of the heating apparatus.

The heating element may be secured within the aerosol generating device by stitching the woven mesh. In this way, an alternative method of securing the heating element to the aerosol generating device is provided, that does not require welding of the mesh, as is typical in known devices. In alternative arrangements, the heating element may be stitched to other components within the aerosol generating device.

### BRIEF DESCRIPTION OF THE DRAWINGS

Embodiments of the invention are now described, by way of example, with reference to the drawings, in which:

FIG. 1 is a schematic view of a heating apparatus for an aerosol generating device in an embodiment of the invention;

FIG. 2 is a schematic top view of a heating element in an embodiment of the invention;

FIG. 3 is a schematic view of the internal structure of a woven heating element in an embodiment of the invention;

FIG. 4 is a schematic view of a heating element comprising fibres of different thicknesses in an embodiment of the invention;

FIG. 5 is a schematic view of the heating element depicted in FIG. 3 comprising an additional interwoven fibre in an embodiment of the invention; and

FIG. 6 is a schematic view of the heating element depicted in FIG. 3 further comprising locally stretched and locally compressed regions in an embodiment of the invention.

### DETAILED DESCRIPTION

FIG. 1 shows a heating apparatus 2 in an embodiment of the invention that comprises a heating element 4, a liquid store 6 and a housing 8. The heating apparatus 2 is configured to be set in an aerosol generating device comprising a battery and a mouthpiece.

In use, the heating element 4 is arranged to receive electrical energy from the battery in order to generate an aerosol by heating an aerosol generating liquid that is drawn onto the heating element 4 from the liquid store 6 via capillary action. One or more airflow channels 10 are provided in the housing 8, and configured to, on user inhalation, direct air from outside the heating apparatus 2 through the air flow channel 10 and toward the mouthpiece of the aerosol generation device. This means that aerosol that has been generated by heating aerosol generating liquid on the heating element 4 will be carried along the air flow channel 10 to exit the device.

The heating element 4 is substantially planar and is mounted in the housing 8. The housing 8 includes a first portion 12 placed above the top major side of the heating element 4 and a second portion 14 placed below the lower major side of the heating element 4 such that the heating element 4 is held between the two housing portions. The housing 8 acts as a vaporisation chamber which is configured to collect generated aerosol within the inner spaces of the two housing portions 12 and 14.

One or more edges of the heating element 4 are exposed to the liquid store 6 which surrounds the housing 8 and heating element 4. The edges of the heating element 4 may extend beyond the outer limits of the heater housing 8, or alternatively the first and second housing portions 12 and 14, when constructed, form a gap between the two housing portions 12 and 14 which allows aerosol generating liquid from the liquid store 6 to come into contact with the heating element edge, whereby the liquid is drawn further across the heating element 4 via capillary action.

The heating element 4 comprises a woven sheet of electrically conductive fibres. The term “sheet” refers to a planar shape with a thickness many times smaller than its length or breadth. However, the skilled person will appreciate a non-planar woven arrangement of electrically conductive fibres may also be used as a heating element. The woven fibres form a porous network of fibres, thereby providing the heating element 4 with wicking properties. Hence, the provision of an additional wicking element to transport vaporisable liquid from the liquid store 6 is not required within the heating apparatus 2.

The thickness of the sheet of heating element 4 may be varied along its length or across its breadth. In one example, the sheet of heating element 4 may be configured such that it is thicker in the centre of the sheet, and thinner at the sheet edge. This arrangement encourages the wicking of liquid from the liquid store at the sheet edge, as more liquid is able to be stored in the thicker central region of the sheet. For example, the thickness of the heating element 4 in the central region may be up to twice the thickness of the heating element 4 in the peripheral region.

In one example, the heating element 4 may be stitched to one or more of the components within the heating apparatus 2. In another example, the heating element 4 may be welded to one or more components.

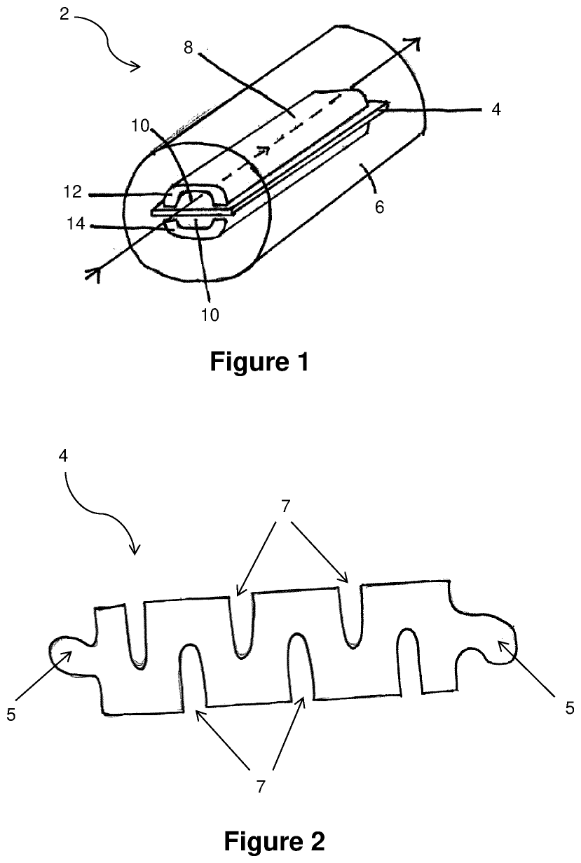

FIG. 2 shows a schematic top view of the heating element 4 in an embodiment of the invention. The heating element 4 has two contact ends 5 which may be connected to a power source (not shown). In use, an electric current passes through the heating element 4 between the contact ends 5, thereby causing the heating element 4 to generate heat. The heating element 4 also includes a plurality of slots 7, which are arranged to cause an electric current to follow a serpentine path as it flows between the two contact ends 5. This results in different concentrations of current along the path, and the establishment of temperature gradients across the heating element. In alternative arrangements, the heating element 4 may comprise a simple shape, such as a rectangle, and different current concentrations may be established across the heating element 4 by alternative means.

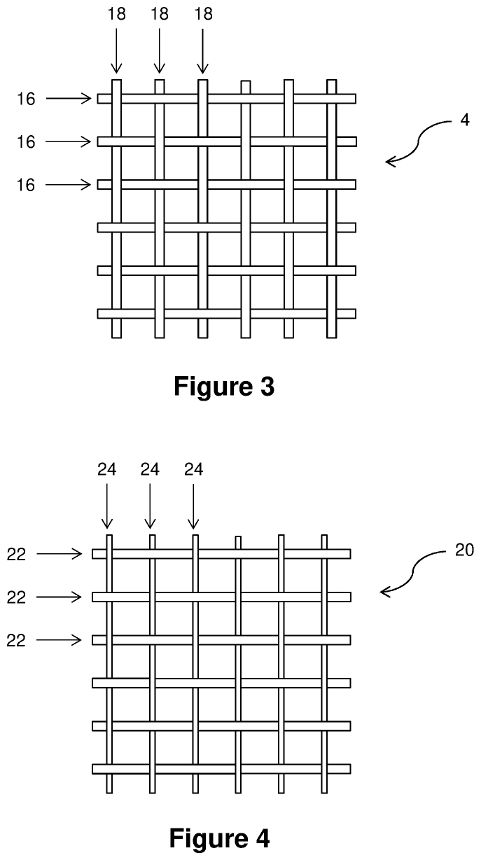

FIG. 3 shows a schematic view of the internal structure of the heating element 4 in an embodiment of the invention. The heating element 4 comprises a first array 16 of electrically conductive fibres extending in a first direction, and a second array 18 of electrically conductive fibres extending in a second perpendicular direction. The fibres in the first array 16 and second array 18 are regularly spaced and woven in a plain weave pattern, such that each fibre of the first array 16 is passed over alternately on a first side and a second opposite side by the second array 18 of fibres, and vice versa, thereby forming a woven planar layer of fibres. Typical interval values for the fibre spacing in each array range from 25 to 500 microns, for example 250 microns.

The fibres of the first array 16 and second array 18 may be made of a metal, such as stainless steel, non-stainless steel, iron, copper, tungsten, aluminium, brass, Nichrome, Kanthal, Cupronickel and other alloys, or any other metal (element, compound or alloy). Alternatively, the fibres may be made of a non-metal material such as molybdenum disilicide, silicon carbide and other ceramics or semiconductors, or any other non-metal. The fibres of the first and second arrays 16 and 18 may be made of the same material or may differ between within each array 16 and 18.

The regular arrangement of fibres reduces the local variation in properties across the heating element 4. Capillary forces act uniformly across the heating element 4 and the variance in current density across the heating element 4 is reduced. In addition, the woven arrangement ensures that each fibre is securely held within the heating element 4, such that the likelihood of fibres becoming loose or falling out of the heating element 4 is low. The mechanical strength of the heating element 4 is also increased.

As will be readily appreciated by the skilled person, the first and second arrays 16 and 18 may be woven into a variety of other patterns. Examples include twill, basketweave, satin or leno arrangement, or any other woven pattern.

In order to ensure liquid is transported to the centre of the heating element 4, the heating element 4 may comprise multiple planar layers of fibres, stacked in a direction perpendicular to the plane of each layer. The multiple layers of woven fibres may be sintered together to improve the homogeneity of the heating element 4. The number of layers may be varied in different regions of the heating element 4, for example to increase the thickness of a central region of the heating element 4.

The skilled person will also appreciate that the heating element 4 may comprise a third array of woven fibres extending in a third direction. In one example, the third direction may be orthogonal to the first and second directions.

FIG. 4 shows a schematic view of an alternative heating element 20 in an embodiment of the invention, for use in heating apparatus 2.

The heating element 20 comprises a first array 22 of electrically conductive fibres extending in a first direction, and a second array 24 of electrically conductive fibres extending in a second perpendicular direction. The fibres in the first array 22 are thicker than the fibres in the second array 24. Hence, the resistance of fibres in the first array 22 is greater than the resistance of fibres in the second array 24 (when the fibres are made out of the same material), and the degree of resistive heating is varied in the first and second directions. As such, a temperature gradient may be established across the heating element 20. Typically, the fibres range in thickness from 25 microns to 250 microns, for example 100 microns.

It will be understood by the skilled person that the fibre thickness may also be varied within the same array, depending on the desired temperature profile across the heating element 20 and other operational requirements.

In an alternative embodiment, the material of each fibre may be varied between arrays 16 and 18, or may differ within each array 16 and 18. This provides an alternative method of varying the fibre resistance in different directions, enabling the establishment of temperature gradients across the heating element 4, or preferential paths for the current to flow.

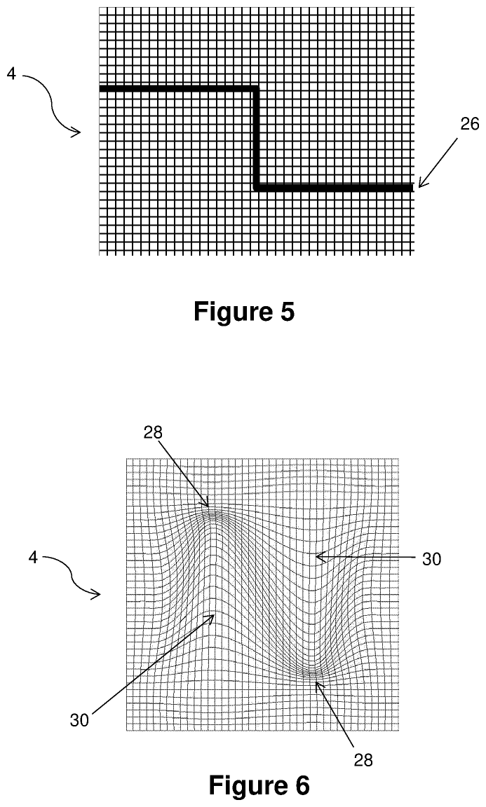

FIG. 5 shows a schematic view of heating element 4 in embodiment of the invention, for use in heating apparatus 2. The heating element 4 comprises an additional material 26 woven into the mesh fibres. In this way, the heating element 4 may be provided with different properties in different regions.

In one example, the additional woven material may be chosen such that it has a higher conductivity than the fibres of the mesh. Hence, when electrical energy is supplied to the heating element 4, a preferential current path is provided. For example, a central region of higher conductivity may be provided across the sheet such that current preferentially flows through the central region, thus preferentially heating the area, creating temperature gradients which can be utilised to optimise the wicking properties of the heating element. In one arrangement, the mesh may comprise aluminium fibres and the additional woven material 26 may comprise Nichrome.

FIG. 6 shows a schematic view of heating element 4 in an embodiment of the invention, for use in heating apparatus 2.

The heating element 4 has been manipulated to provide locally compressed regions 4 having a reduced spacing between fibres, and locally stretched regions 30 having an increased spacing between fibres. The locally stretched region 30 will produce an area of high current density, and the locally compressed region 28 will produce an area of low current density. Areas of high current density will become hotter than areas of low current density, such that a temperature gradient is established across the mesh.

In addition, the change in spacing between fibres will alter the size of interstices within the mesh, leading to a variation in capillarity properties or possibly the provision of a preferential current path. The size and frequency of compressed and stretched regions 28 and 30 may be tailored according to the operational requirements of the heating element 4.

1. A heating apparatus for an aerosol generating device, comprising:
a heating element supported within a housing and extending along a length of the housing;
an air flow path arranged to transport air over the heating element; and
a liquid supply configured to supply liquid to the heating element,
wherein the heating element comprises a woven sheet of electrically conductive fibres,
wherein the electrically conductive fibres are arranged with a regular orientation to form a woven mesh configured to transports liquid by capillary action, in use, and
wherein the woven sheet comprises:
a first array of electrically conductive fibres extending in a first direction.

2. The heating apparatus of claim 1, wherein the electrically conductive fibres are displaced at regular intervals.

3. The heating apparatus of claim 1, wherein the woven sheet further comprises:
a second array of electrically conductive fibres extending in a second direction,
wherein the first array of electrically conductive fibres and the second array of electrically conductive fibres intersect to form the woven mesh.

4. The heating apparatus of claim 3, wherein the mesh is woven such that each fibre in the first array alternately winds over opposite sides of subsequent fibres of the second array.

5. The heating apparatus of claim 4, wherein the mesh is woven such that each fibre in the second array alternately winds over opposite sides of subsequent fibres of the first array.

6. The heating apparatus of claim 3, wherein the first and second directions are substantially orthogonal.

7. The heating apparatus of claim 1, wherein the woven sheet of the heating element comprises one or more slots extending inwardly from at least one edge of the woven sheet.

8. The heating apparatus of claim 3, further comprising at least one additional fibre woven into the mesh, wherein the at least one additional fibre comprises a different material to the electrically conductive fibres of the first and second arrays.

9. The heating apparatus of claim 3, further comprising a third array of electrically conductive fibres extending in a third direction,
wherein the third array of electrically conductive fibres is arranged to intersect with the first array of electrically conductive fibres and the second array of electrically conductive fibres.

10. The heating apparatus of claim 9, wherein the third direction is substantially orthogonal to the first direction and the second direction.

11. The heating apparatus of claim 9, wherein at least two of the first, second and third arrays of electrically conductive fibres comprise different materials and/or different fibre thicknesses.

12. The heating apparatus of claim 1, wherein at least one region of the mesh is stretched or compressed relative to a surrounding region of the mesh.

13. The heating apparatus of claim 1, wherein a thickness of the mesh in a central region is greater than a thickness of the mesh in a peripheral region.

14. The heating apparatus of claim 1, wherein the liquid supply at least partially surrounds the housing and is configured to directly interface with the heating element along the length of the housing.

15. An aerosol generating device comprising the heating apparatus of claim 1, wherein the heating element is secured within the aerosol generating device by stitching the woven mesh.
